(19) United States
(12) Patent Application Publication
(10) Pub. No.: US 2012/0183650 A1
(43) Pub. Date: Jul. 19, 2012

(54) Packaged Food Product and Method of Packaging a Food Product

(76) Inventor: Durga LISKE, Winnipeg (CA)

(21) Appl. No.: 13/009,043

(22) Filed: Jan. 19, 2011

(51) Int. Cl. B65D 85/74

(52) U.S. Cl. 426/87; 426/392; 426/396; 426/106; 426/122

(57) ABSTRACT

A method of packaging a moldable food product includes providing a base tray having a plurality of compartments arranged in an array, wherein each of the compartments has an interior space defining a volume for storing the moldable food product, an open end, and inter-compartmental walls extending from the open end on at least two sides; filling the compartments with the moldable food product, wherein the moldable food product is in a first phase; cooling the moldable food product in each of the compartments to increase a solidity of the moldable food product with respect to the first phase to allow the moldable food product to conform to the shape of the interior space of the compartment; and sealing the filled compartments so as to cover the open ends of the compartments.

### BACKGROUND OF THE INVENTION

1. Field of the Invention

The present invention relates to a method of packaging a moldable food product and a package of a moldable food product.

2. Background Art

The food packaging industry is concerned with a variety of factors when creating packaging for a food product, including efficiency of the packaging process, in terms of both time and cost, unit size of the food product, environmental impact of the packaging and/or shelf life of the food product.

Baking products, such as butter or margarine, are traditionally manufactured as quarter pound sticks wrapped in parchment paper. Four quarter pound sticks are then packaged in a cardboard package and sold as one pound units. However, wrapping sticks of butter or margarine in parchment paper can be a time consuming and costly process and the outer cardboard package creates extra waste that generally ends up in a landfill. There is a need in the food packaging industry to improve the packaging of food products similar to butter or margarine given the concerns noted above.

### BRIEF SUMMARY OF THE INVENTION

The present invention is directed to a process of packaging a moldable food product, including: providing a base tray having a plurality of compartments arranged in an array, wherein each of the compartments has an interior space defining a volume for storing the moldable food product, an open end, and inter-compartmental walls extending from the open end on at least two sides; filling the compartments with the moldable food product, wherein the moldable food product is in a first phase; sealing the filled compartments so as to cover the open ends of the compartments; and cooling the moldable food product in each of the compartments to increase a solidity of the moldable food product with respect to the first phase to allow the moldable food product to conform to the shape of the interior space of the compartment.

In some embodiments, sealing includes covering the open ends of the compartments with a removable film.

In some embodiments, the removable film is perforated so that the compartments can be uncovered individually.

In some embodiments, filling includes dispensing the moldable food product heated in a range from 10 degrees Celsius to 26 degrees Celsius.

In some embodiments, the base tray is vibrated after filling the compartments with the moldable food product in order to level the moldable food product.

In some embodiments, the first phase is a liquid phase or semi-liquid phase and cooling includes refrigerating the base tray with the filled compartments for a sufficient time to increase the solidity of moldable food product in the compartments.

In some embodiments, the base tray is a food safe plastic material.

In some embodiments, the base tray further includes points of weakness on the inter-compartmental walls so that each compartment may be separated from a remainder of the compartments.

In some embodiments, the points of weakness are perforations and the at least two inter-compartmental walls of each compartment can be separated along the points of weakness to remove each compartment from adjacent compartments of the base tray.

In some embodiments, the interior space of each compartment is sufficient for storing 7 g to 8 kg of the moldable food product. In some embodiments, the interior space of each compartment is sufficient for storing 1 tsp to 1 gallon (5 mL to 4.5 L) of the moldable food product.

In some embodiments, the plurality of compartments includes a range from 2 to 72 compartments.

In some embodiments, the base tray includes four compartments.

In some embodiments, the base tray includes twelve compartments.

In some embodiments, the compartments further includes an indicium of a unit of gradation.

In some embodiments, the indicium is located in the interior space of the compartments so as to imprint the indicium on the moldable food product after increasing the solidity of the moldable food product.

In some embodiments, the indicium is located on the inter-compartmental walls.

In some embodiments, the moldable food product is chosen from the group consisting of butter, margarine, shortening, lard, and chocolate.

The present invention is also directed to a package of moldable food product including: a base tray having a plurality of compartments arranged in an array, wherein each of the compartments has an interior space defining a volume for storing a moldable food product, an open end, and inter-compartmental walls extending from the open end on at least two sides; a moldable food product contained in the interior space of each compartment and molded to a shape of the interior space of each compartment; and a cover which seals the open ends of the compartments.

In some embodiments, the package of moldable food product further includes an indicium of a unit of gradation.

In some embodiments, the package of moldable food product includes an indicium of a unit of gradation which includes 1 teaspoon, 1 tablespoon, 1/4 cup, 1/3 cup, 1/2 cup, and 1 cup.

In some embodiments, the package of moldable food product includes a cover wherein the cover is a removable film.

In some embodiments, the package of moldable food product includes a removable film wherein the removable film is perforated so that the compartments can be uncovered individually.

In some embodiments, the package of moldable food product includes a plurality of compartments wherein the plurality of compartments includes a range from 2 to 72 compartments and wherein the volume for storing the moldable food product is sufficient for containing the moldable food product in an amount in a range from 7 g to 8 kg.

In some embodiments, the package of moldable food product includes a base tray wherein the base tray includes four compartments and wherein the volume for storing a moldable food product is sufficient for containing a ¼ lb of the moldable food product.

In some embodiments, the package of moldable food product includes a base tray wherein the base tray includes twelve compartments and wherein the volume for storing a moldable food product is sufficient for containing a ¼ lb of the moldable food product.

In some embodiments, the package of moldable food product includes a base tray wherein the base tray further includes points of weakness on the inter-compartmental walls so that each compartment may be separated from a remainder of the compartments.

In some embodiments, the package of moldable food product includes points of weakness wherein the points of weakness are perforations and wherein the at least two inter-compartmental walls of each compartment can be detached along the points of weakness to remove each compartment from adjacent compartments of the base tray.

### BRIEF DESCRIPTION OF THE DRAWINGS/FIGURES

The accompanying drawings, which are incorporated herein and form a part of the specification, illustrate the present invention by way of example, and not by way of limitation. The drawings together with the description, further serve to explain the principles of the invention and to enable a person skilled in the pertinent art to make and use the invention.

FIG. 1 is a flowchart of an exemplary method for packaging a food product according to some embodiments of the present invention.

FIG. 2 is perspective view of an exemplary packaged food product with an array of compartments according to some embodiments of the present invention.

FIG. 3 is a perspective view of an exemplary single compartment of a packaged food product according to some embodiments of the present invention.

FIG. 4 is a side view of the compartment of FIG. 3.

FIG. 5 is a perspective view of an exemplary base tray according to some embodiments of the present invention.

FIG. 6 is a plan view of the packaged food product of FIG. 2.

FIG. 7 is a detailed view of an exemplary corner of one compartment of the base tray in FIG. 6.

FIG. 8 is a side view of the packaged food product of FIG. 2.

FIG. 9 is a side view of the compartment of FIG. 3.

FIG. 10 is a flowchart of an alternative method for packaging a food product according to some embodiments of the present invention.

### DETAILED DESCRIPTION OF THE INVENTION

The present invention will be described with reference to the accompanying drawings, in which like reference numerals refer to similar elements. While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

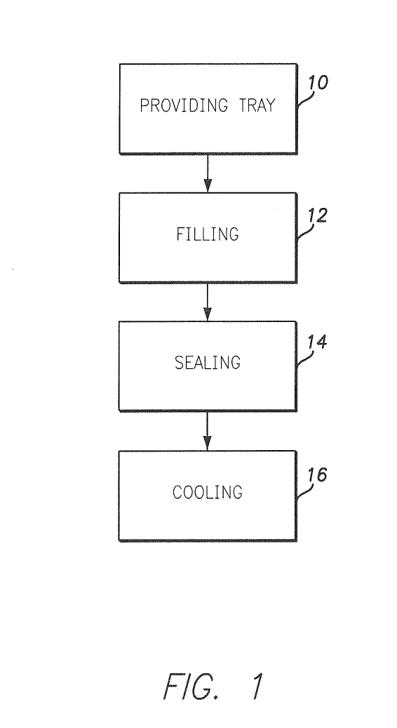

FIG. 1 illustrates a flowchart of an exemplary method of packaging a food product. The method can include a process 10 of providing a base tray having a plurality of compartments, a process 12 of filling the compartments with the food product wherein the food product is in a first phase, a process 14 of sealing the filled compartments so as to cover open ends of the compartments, and a process 16 of cooling the food product to a second phase to allow the food product to conform to a shape of the interior space of the compartment. The order of the processes shown in the flowchart of FIG. 1 is merely exemplary and additional processes can be included. In addition, the order of processes shown in the flowchart of FIG. 1 is merely exemplary and the processes can be performed in different orders. For example, in some embodiments, process 16 of cooling can occur before process 14 of sealing.

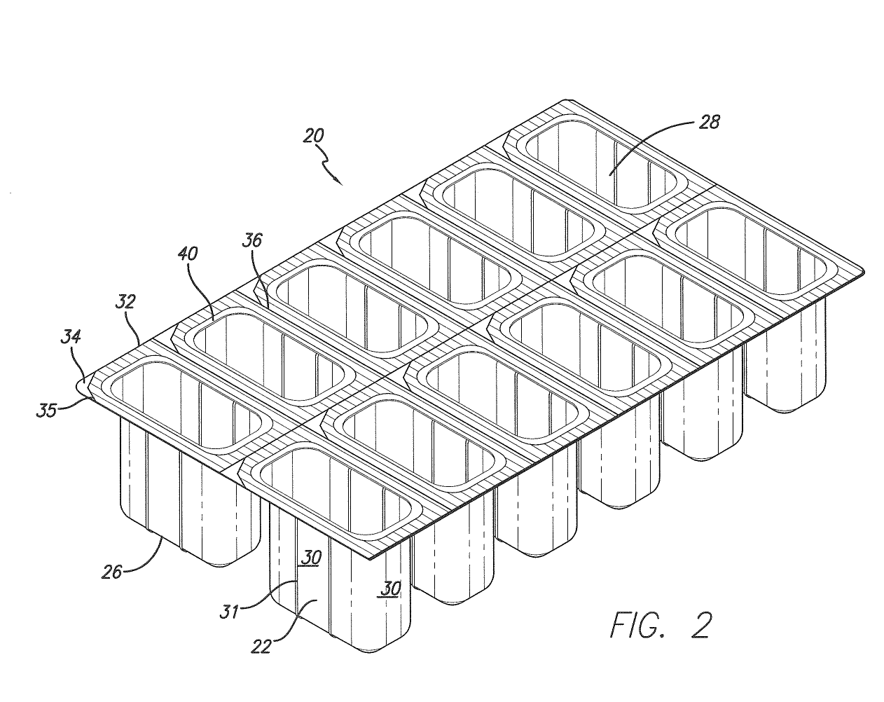

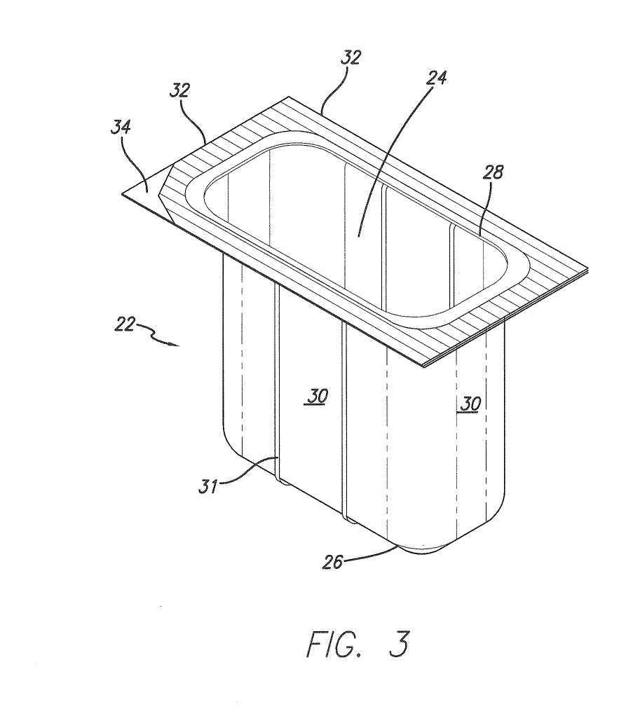

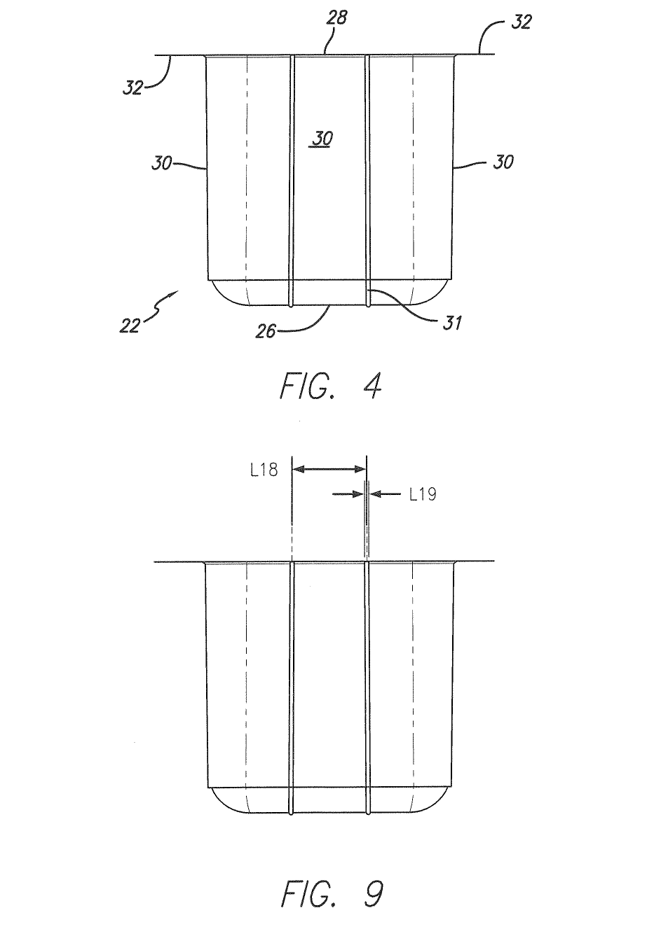

An exemplary packaged food product that results from the exemplary method illustrated in FIG. 1 is shown in FIG. 2. The packaged food product can include a base tray 20 having a plurality of compartments 22 arranged in an array. As shown in FIG. 3 and FIG. 4, each compartment 22 can have an interior space 24 defined by a bottom surface 26, an open end 28 opposite bottom surface 26, and one or more walls 30 extending from bottom surface 26 to form open end 28. Inter-compartmental walls 32 can extend from open end 28 substantially perpendicular to walls 30 on at least two sides to join with inter-compartmental walls 32 of adjacent compartments 22. In some embodiments, walls 30 can have one or more ridges 31 that extend longitudinally outward from interior space 24. A film 34 is sealed to inter-compartmental walls 32 to cover a food product (not shown) located in interior space 24 of each compartment 22. Each compartment can have a rounded corner 35 that provides a pull tab for pulling film 34 off of compartment 22 to provide access to a food product (not shown) located in interior space 24 of compartment 22

In some embodiments, process 10 can including providing base tray 20. Base tray 20 can have an array of compartments 22. In some embodiments, for example, there can be two compartments, four compartments, eight compartments, twelve compartments, twenty-four compartments, thirty-six compartments, forty-eight compartments, sixty compartments, or seventy-two compartments.

In some embodiments, interior space 24 of each compartment 22 can have a sufficient volume for storing a desired food product. For example, interior space 24 can have a volume sufficient to store food products ranging in weight from about seven grams to about eight kilograms. In some embodiments, the interior space of each compartment is sufficient for storing 1 tsp to 1 gallon (5 mL to 4.5 L) of the moldable food product.

Base tray 20 can be any food safe plastic material known in the art, including bioplastics. In some embodiments, material for base tray 20 has sufficient flexibility and can withstand temperatures in a range from −10 degrees Celsius to 40 degrees Celsius.

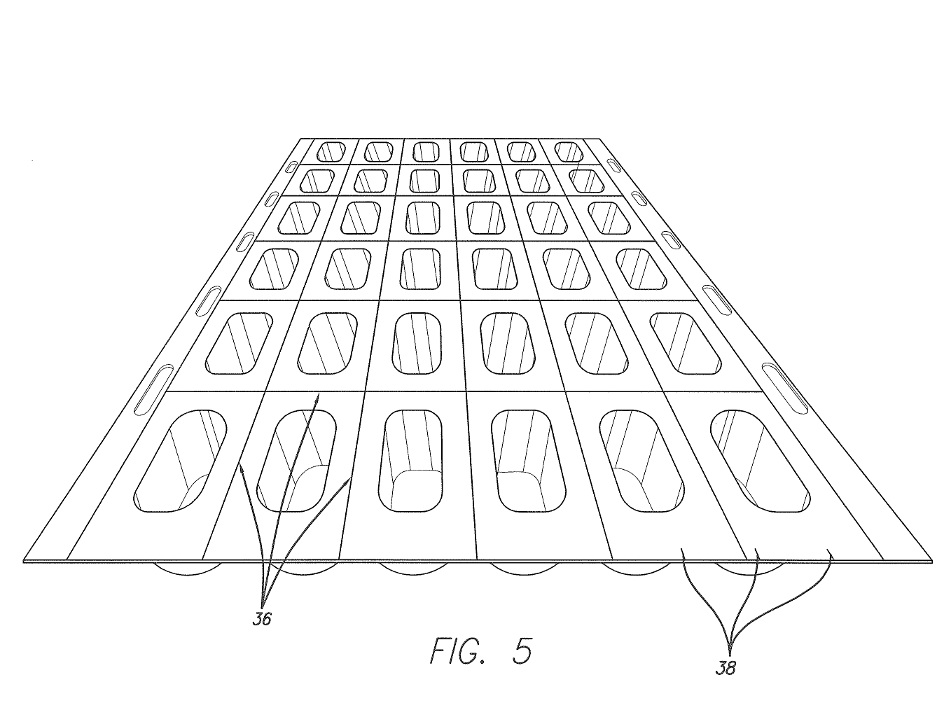

In some embodiments, base tray 20 can also include points of weakness 36 to allow an individual compartment 22 to be separated from adjacent compartments of the base tray 20, as shown in FIG. 5, which illustrates an embodiment wherein base tray 20 has 36 compartments arranged in array of 6 by 6. Points of weakness 36 can be formed on inter-compartmental walls 32 of at least two sides of each compartment 22 such that the inter-compartmental wall 32 can be broken, thus releasing compartment 22 from a remainder of the base tray 20. Points of weakness 36 can be in the form of perforations and can be molded, cut, drilled, or rolled into base tray 20.

In some embodiments, base tray 20 can include indicia of a unit of measure 38, as shown in FIG. 5. In some embodiments, indicia of a unit of measure 38 can be disposed on, or in, inter-compartmental walls 32 or a face of wall 30 in interior space 24. In some embodiments, indicia of a unit of measure 38 can be printed on compartments 22 of base tray 20. In some embodiments, indicia of a unit of measure 38 can be molded into compartments 22 or base tray 20. In some embodiments, indicia of a unit of measure 38 can be molded located in the interior of compartments 22 such that the indicia of a unit of measure 38 is imprinted on the moldable food product after the food product has cooled to a more solid state.

In some embodiments, indicia of a unit of measure 38 can indicate the volume or weight of the moldable food product in each compartment 22. For example, indicia of a unit of measure 38 can be in units of 1 teaspoon, 1 tablespoon, ¼ cup, ⅓ cup, ½ cup, 1 cup, 1 ounce, ¼ lb, ½ lb, 1 lb, 1 gram, ¼ kg, ½ kg, 1 kg, 5 mL, 10 mL or 250 mL increments. Indicia of a unit of measure 38 can also include recipe specific units. For example, the indicia of a unit of measure can indicate 14 oz. of the moldable food product for use in a recipe calling for such an amount.

In some embodiments, the food product filled into compartments 22 in process 12 can include a moldable food product. As used herein, “a moldable food product” refers to a food product that can be molded to conform to a shape of a container as the solidity of the food product increases. In some embodiments, the moldable food product can include butter, margarine, shortening, chocolate, or animal fat (e.g., lard). In some embodiments, the filling process of process 12 can include injecting or squirting heated food product from a nozzle into compartments 22. In some embodiments, the food product can be heated in a range of 10 to 26 degrees Celsius, depending upon the properties of the specific food product, such as, whether the food product is hydrogenated or not, when the food product is filled into compartments 22. In some embodiments, compartments 22 can be filled with a food product that is in a liquid phase. Liquid phase, as utilized herein, includes a semi-liquid (i.e., an item that does not hold its shape, but is more viscous than a liquid).

In some embodiments, process 14 of sealing can include covering open end 28 of compartments 22 of base tray 20 with film 34. In some embodiments, film 34 can be molded, glued, or heat sealed to compartment 22. In some embodiments, film 34 can be attached such that the food product can be pushed out of compartment 22 causing film 34 to at least partially release from the inter-compartmental walls 38. In some embodiments, film 34 can be perforated so that individual compartments 22 can be uncovered individually. In some embodiments, film 34 can be applied in process 16 of sealing such that it can be resealable. Film 34 can be any material which can create a barrier for controlled atmosphere. In some embodiments, for example, film 34 can be a transparent or opaque plastic or foil. In some embodiments, film 34 can be constructed from one or more layers of a given material and can include nylons, ethylene vinyl alcohol (EVOH), metallocene linear low density polyethylene (mLLDPE), or other advanced polymers. Certain combinations of different materials can also be employed to provide product specific solutions for a given food product. In some embodiments, film 34 has thickness in a range of 14 mm to 26 mm.

In some embodiments, process 16 of cooling can include placing tray 20 in a reduced temperature environment (e.g., refrigerating) or allowing the food product to air cool over time. In some embodiments, for example, a base tray 20 can be placed in an environment below 7 degrees C. to allow the moldable food product to cool. In some embodiments, process 14 of cooling can allow a food product heated to a liquid phase in process 12 to at least partially solidify to conform to the interior of compartment 22. In some embodiments, the food product can change phases, for example from a liquid phase to a semi-liquid phase, from a liquid phase to a solid phase, or from a semi-liquid phase to a solid phase. In some embodiments, the duration of process 14 of cooling can be varied as to accommodate different food products. For example, in some embodiments, the duration of process 14 of cooling is dependent upon the oil components in the food product such that, for example, a food product high in saturated fat can cool more rapidly than a food product low in saturated fat and, thus, the required duration of process 14 of cooling can be less for a food product high in saturated fat.

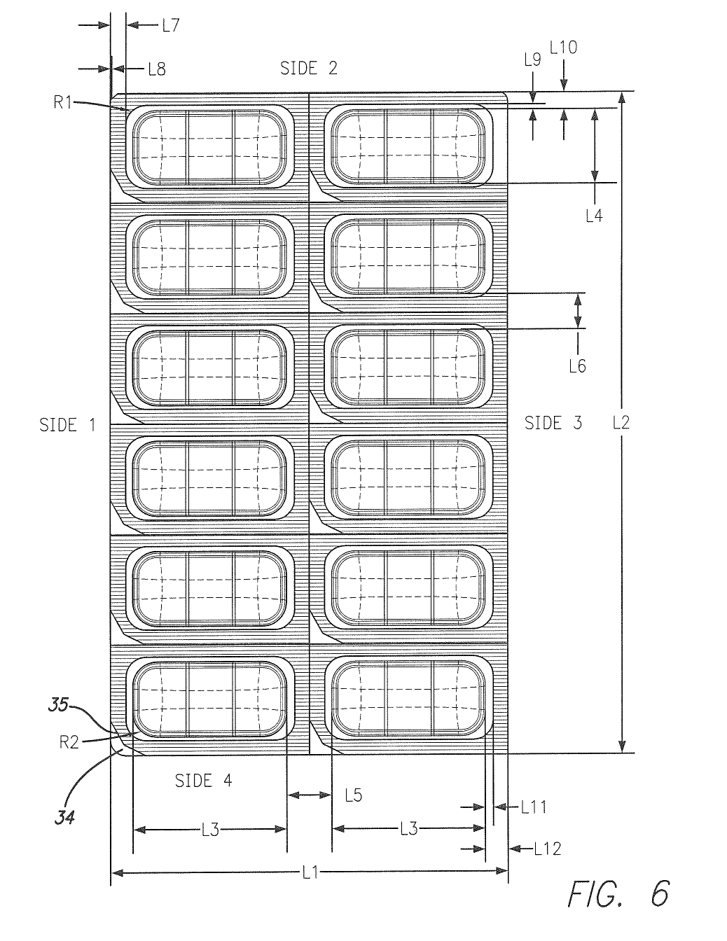

The packaged food product can have a base tray 20 with a variety of configurations based on the particular food product, as well as the quantity of the food product for each compartment 22. In some embodiments, as shown for example in FIG. 1 and FIG. 6, the packaged food product includes a base tray 20 having an array of twelve compartments 22 arranged in a 2 by 6 configuration with each compartment having a generally rectangular shape consisting of two narrow sides, Side 1 and Side 3, and two long sides, Side 2 and Side 4, as shown in FIG. 6. For the purposes of the following description, the narrow side of each compartment 22 with rounded corner 35 is Side 1 and the opposite narrow side of each compartment 22 without a rounded corner 35 is Side 3. The long side of each compartment 22 without rounded corner 35 is Side 2 and the opposite long side of each compartment 22 with the rounded corner 35 is Side 4. Thus, rounded corner 35 is situated at the corner of narrow Side 1 and long Side 4. Likewise, with regard to base tray 20 itself, Side 1 of base tray 20 is the side on which Side 1 of a series of compartments 22 are aligned, and Side 3 of the base tray 20 is the side on which Side 3 of a series of compartments are aligned. The same applies to Side 2 and Side 4. The measurements and features described below are merely exemplary.

In some embodiments, a distance L1 measures an overall width of the 2 by 6 tray from the edge of inter-compartmental walls 32 on Side 1 of the tray to the edge of inter-compartmental walls 32 on Side 3 of the tray. Distance L1 can be in a range of 155 mm to 160 mm, such as about 156.67 mm. In some embodiments, a distance L2 measures an overall length of the 2 by 6 tray measured from the edge of inter-compartmental walls 32 on Side 2 of the tray to the edge of inter-compartmental walls 32 on Side 4 of the tray. Distance L2 can be in a range of 265 mm to 270 mm, such as about 268.5 mm.

Each compartment 22 can have a chamfered edge 40 below open end 28 to define interior space 24. In some embodiments, a distance L3 measures a length of each compartment 22 along Side 2 and Side 4 from the interior of chamfered edge 40 along Side 1 to the interior of chamfered edge 40 along Side 3. Distance L3 can be in a range of 60 mm to 62 mm, such as about 60.33 mm. In some embodiments, a distance L4 measures a width of each compartment 22 along narrow Side 1 and Side 3 from the interior of chamfered edge 40 along Side 2 to the interior of chamfered edge 40 along Side 4. Distance L4 can be in a range of 28 mm to 30 mm, such as about 29.75 mm.

In some embodiments, a distance L5 measures a spacing between adjacent interconnected compartments along Side 2 and Side 4, in particular between the interior of chamfered edge 40 on Side 1 of a first compartment 22 to the interior of chamfered edge 40 on Side 3 of a second and adjacent compartment 22. Distance L5 can be in a range of 17 mm to 19 mm, such as about 18 mm. In some embodiments, distance L6 measures a spacing between adjacent compartments along Side 1 and Side 3, measured from the interior of chamfered edge 40 on Side 2 of a first compartment 22 to the interior of chamfered edge 40 on Side 4 of a second and adjacent compartment 22. Distance L6 can be in a range of 14 mm to 16 mm, such as about 15 mm.

In some embodiments, a distance L7 measures a distance from the inner edge of inter-compartmental wall 32 of a compartment 22 to the edge of film 34 along Side 1. Distance L7 can be in a range of 5 mm to 7 mm, such about 5.5 mm. In some embodiments, a distance L8 measures a distance from the edge of film 34 to the outer edge of inter-compartmental wall 32 of compartment 22 along Side 1. Distance L8 can be in a range of 0.3 mm to 0.7 mm, such as about 0.5 mm. In some embodiments, along Side 2 and Side 4, a distance L9 measures a width of chamfered edge 40 of a compartment 22. Distance L9 can be in a range of 1 mm to 2 mm, such as about 1.5 mm. In some embodiments, a distance L10 measures a distance from the interior of chamfered edge 40 to the edge along Side 2 or Side 4 of inter-compartmental wall 32. Distance L10 can be in a range of 6 mm to 8 mm, such as about 7.5 mm. In some embodiments, along Side 1 and Side 3 of each compartment 22, a distance L11 measures the width of chamfered edge 40 of a compartment 22. Distance L11 can be in a range of 2 mm to 4 mm, such as about 3 mm. In some embodiments, a distance L12 measures a distance from the interior of chamfered edge 40 along Side 1 or Side 3 to the outer edge of inter-compartmental wall 32 on Side 1 or Side 3. Distance L11 can be in a range of 8 mm to 10 mm, such as about 9 mm.

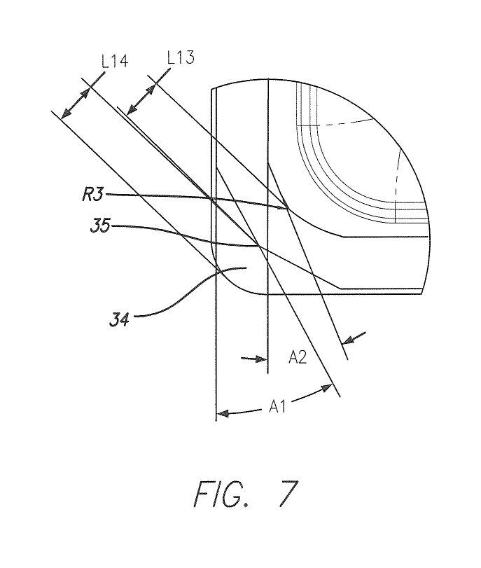

In some embodiments, the outside of chamfered edge 40 of a compartment 22 can have a radius R1 as shown in FIG. 6. Radius R1 can be in a range of 7 min to 9 mm, such as about 8 mm. In some embodiments, the inside of chamfered edge 40 of a compartment 22 can have a radius R2 as shown in FIG. 6. Radius R2 can be in a range of 9 mm to 11 mm, such as about 10 mm. In some embodiments, chamfered edge 40 of compartment 22 nearest rounded corner 35, can have a radius R3 as shown in FIG. 7. Radius R3 can be in a range of 4 mm to 6 mm, such as about 5 mm. In some embodiments, an angle A1 can measure an angle of curvature of the outside edge of inter-compartmental wall 32 at rounded corner 35. Angle A1 can be in a range of 25 degrees to 30 degrees, such as about 28 degrees. In some embodiments, an angle A2 can measure an angle of curvature of the inside edge of inter-compartmental wall 32 at rounded corner 35. Angle A1 can be in a range of 20 degrees to 24 degrees, such as about 22 degrees. In some embodiments, a distance L13 measures a distance between an apex of the outer curve of inter-compartmental wall 32 at rounded corner 35 and an apex of the inner curve of inter-compartmental wall 32 at rounded corner 35. Distance L13 can be in a range of 4 mm to 6 mm, such as about 5 mm. In some embodiments, a distance L14 measures a distance between an apex of the outer curve of inter-compartmental wall 32 at rounded corner 35 an apex of the curve of film 34 at rounded corner 35. Distance L14 can be in a range of 4 mm to 6 mm, such as about 4.75 mm.

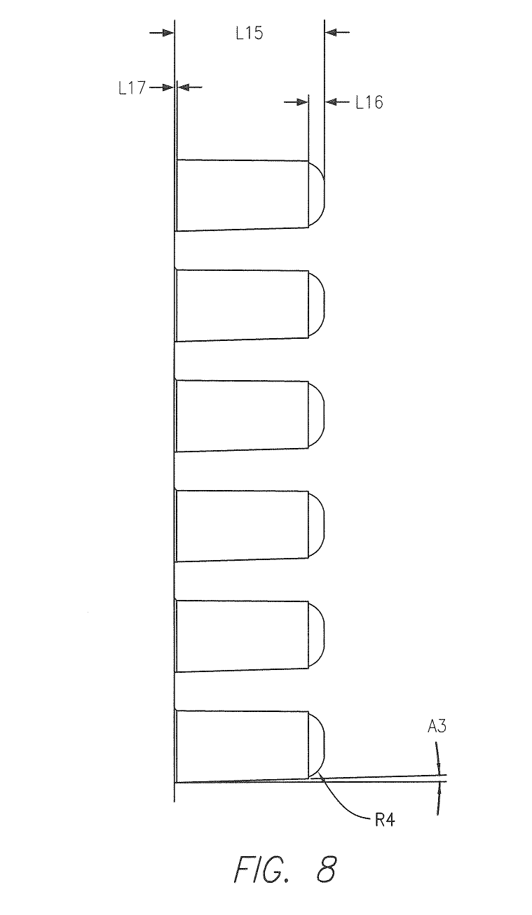

In some embodiments, a distance L15 measures an overall depth of each compartment 22 in the 2 by 6 tray as shown in FIG. 8. Distance L15 can be in a range of 40 mm to 70 mm, such as about 60 mm. In some embodiments, a bottom portion of each compartment 22 can be rounded and can have a radius R4. Radius R4 can be in a range of 8 mm to 12 mm, such as about 10 mm. In some embodiments, a distance L16 measures a depth of the rounded bottom of compartment 22. Distance L16 can be in a range of 5 mm to 7 mm, such as about 6 mm. In some embodiments, a distance L17 measures a thickness of inter-compartmental walls 32 of each compartment 22. Distance L17 can be in a range of 0.3 mm to 0.7 mm, such as about 0.5 mm. In addition, in some embodiments, walls 30 along Side 2 and Side 4 of each compartment 22 can be offset at an angle A3 from an imaginary line perpendicular to the inter-compartmental wall 32. Angle A3 can be about 1 degree.

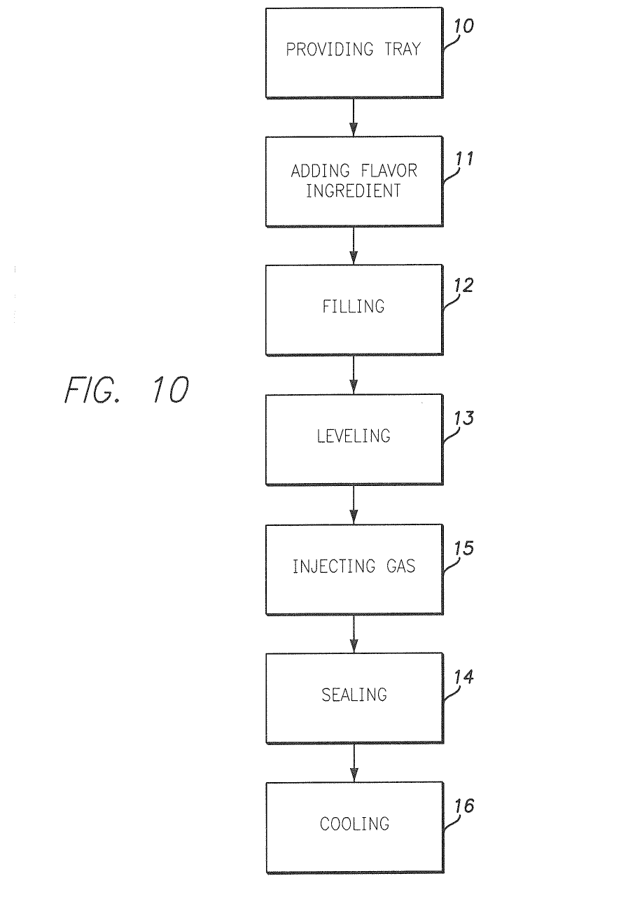

As shown in FIG. 9, in some embodiments, compartment 22 can have two ridges 31. In some embodiments, a distance L18 measures a distance between ridges 31. Distance L18 can be in a range of 15 mm to 20 mm, such as about 18 mm. In some embodiments, a distance L19 measures a width of ridges 31. Distance L19 can be in a range of 0.5 mm to 1.5 mm, such as about 1 mm.

In some embodiments, compartments 22 can be configured to hold ¼ lb of margarine having a density of 0.0329 pounds per cubic inch. Each compartment can have a width of 1.5 in, a length of 2.5 in, and a depth of 2.375 in. When filled with a ¼ lb of margarine, each compartment can be filled to a depth of 2.15 in, such that the margarine can occupy a volume of 7.60 cubic inches.

In some embodiments, compartments 22 can be configured to hold 1 lb of margarine having a density of 0.0329 pounds per cubic inch. Each compartment can have a width of 2.5 in, a length of 6.375 in, and a depth of 2.375 in. When filled with 1 lb of margarine, each compartment can be filled to a depth of 2.15 in, such that the margarine can occupy a volume of 30.4 cubic inches.

In some embodiments, compartments 22 can be configured to hold 3 lb of margarine having a density of 0.0329 pounds per cubic inch. Each compartment can have a width of 5.75 in, a length of 5.75 in, and a depth of 3 in. When filled with 3 lb of margarine, each compartment can be filled to a depth of 2.78 in, such that the margarine can occupy a volume of 91.19 cubic inches.

In some embodiments, compartments 22 can be configured to hold 4 lb of margarine having a density of 0.0329 pounds per cubic inch. Each compartment can have a width of 5.75 in, a length of 5.75 in, and a depth of 4 in. When filled with 4 lb of margarine, each compartment can be filled to a depth of 3.7 in, such that the margarine can occupy a volume of 121.58 cubic inches.

As illustrated by the flow chart in FIG. 10, the method for packaging a moldable food product can include additional steps from those outlined in the flow chart of FIG. 1. In some embodiments a method for packaging a moldable food product can include a process 10 of providing a base tray having a plurality of compartments (as discussed above), a process 11 of adding a flavor ingredient into the compartments to flavor the food product, a process 12 of filling the compartments with a food product wherein the food product is in a first phase (as discussed above), a process 13 of leveling the food product so that the food product can be evenly distributed throughout the compartment), a process 15 of injecting gas into the compartments containing the food product wherein the gas can aid in preserving and increasing the shelf life of the food product, a process 14 of sealing the filled compartments so as to cover open ends of the compartments (as discussed above), and a process 16 of cooling the food product to a second phase to allow the food product to conform to a shape of the interior space of the compartment (as discussed above. The order of the processes shown in the flowchart of FIG. 10 is merely exemplary and additional processes can be included. In addition, the order of processes shown in the flowchart of FIG. 10 is merely exemplary and the processes can be performed in different orders. For example, in some embodiments, process 16 of cooling can occur before process 15 of injecting gas and process 14 of sealing.

In some embodiments, process 11 of adding a flavor ingredient can include spraying, injecting, dumping or any other suitable means of adding the flavor ingredient into compartment 22. In some embodiments, the flavor ingredient added in process 11 can include, for example, garlic, herb, cinnamon, or any other suitable flavor ingredient. In some embodiments, such as illustrated in FIG. 10 for example, the process 11 of adding a flavor ingredient can occur before process 12 of filling such that the flavor ingredient is added into each compartment prior to filling the tray with a moldable food product in process 12.

In some embodiments, process 13 of leveling can include shaking, vibrating, or rocking base tray 20 back and forth to achieve a substantially even distribution of the food product inside each compartment 22. In some embodiments, the frequency and duration of process 13 can be varied based upon the specific food product in compartment 22. In some embodiments, for example, the frequency and duration of process 13 can be dependent upon the amount of saturated fat in the moldable food product. Process 13 of leveling can also be used to remove air from the moldable food product in compartment 22. In some embodiments, process 13 of leveling can also aid in mixing the flavor ingredient of process 11 with the food product.

In some embodiments, process 15 of injecting gas can include injecting nitrogen, carbon dioxide, or a combination of the two into compartments 22. In some embodiments the gas injected in process 15 can occur simultaneously with process 12 of injecting a moldable food into compartment 22. In some embodiments, the gas injected in process 15 can extend the shelf life of the moldable food product. For example, by injecting nitrogen, carbon dioxide, or a mixture of the two, the shelf life of the moldable food product can be increased by at least 10 percent, at least 20 percent, at least 30 percent, at least 40 percent or at least 50 percent.

In some embodiments, the packaged product can be sold as is to reduce unnecessary packaging and be more environmentally friendly. In some embodiments, for example, product identification and labeling can be printed on film 34 to allow the product to be identified and sold without additional packaging. In some embodiments, the packaged product can be placed in an outer covering, such as cardboard, for example.

In some embodiments, the compartments 22 can have serial number or bar codes imprinted thereon to facilitate traceability of products. For example the serial number or bar codes can be used in identifying products to be recalled, tracking products with a particular expiration date, and the ability to intermingle products from different manufacturing lots while retaining the ability to identify and track specific products. In some embodiments, serial numbers or bar codes can be printed on film 34 to facilitate identification of recalled products.

Thus, the present invention provides a packaged moldable food product with increased shelf life wherein the package moldable food product is made by a process including providing a base tray having a plurality of compartments arranged in an array, wherein each of the compartments has an interior space defining a volume for storing the moldable food product, an open end, and inter-compartmental walls extending from the open end on at least two sides; filling the compartments with the moldable food product, wherein the moldable food product is in a first phase; cooling the moldable food product in each of the compartments to increase a solidity of the moldable food product with respect to the first phase to allow the moldable food product to conform to the shape of the interior space of the compartment; and sealing the filled compartments so as to cover the open ends of the compartments.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents,

What is claimed is:

1. A method of packaging a moldable food product, comprising:
(a) providing a base tray having a plurality of compartments arranged in an array, wherein each of the compartments has an interior space defining a volume for storing the moldable food product, an open end, and inter-compartmental walls extending from the open end on at least two sides;
(b) filling the compartments with the moldable food product, wherein the moldable food product is in a first phase;
(c) cooling the moldable food product in each of the compartments to increase a solidity of the moldable food product with respect to the first phase to allow the moldable food product to conform to the shape of the interior space of the compartment; and
(d) sealing the filled compartments so as to cover the open ends of the compartments.

2. The method according to claim 1, wherein sealing comprises covering the open ends of the compartments with a removable film.

3. The method according to claim 2, wherein the removable film is perforated so that the compartments can be uncovered individually.

4. The method according to claim 1, wherein filling comprises dispensing the moldable food product heated in a range from 10 degrees Celsius to 26 degrees Celsius.

5. The method according to claim 1, wherein the base tray is vibrated after filling the compartments with the moldable food product in order to level the moldable food product

6. The method according to claim 1, wherein the first phase is a liquid phase or semi-liquid phase and wherein cooling comprises refrigerating the base tray with the filled compartments for a sufficient time to increase the solidity of moldable food product in the compartments.

7. The method according to claim 1, wherein the base tray is a food safe plastic material.

8. The method according to claim 1, wherein the base tray further comprises points of weakness on the inter-compartmental walls so that each compartment may be separated from a remainder of the compartments.

9. The method according to claim 8, wherein the points of weakness are perforations, and wherein the at least two inter-compartmental walls of each compartment can be separated along the points of weakness to remove each compartment from adjacent compartments of the base tray.

10. The method according to claim 1, wherein the interior space of each compartment is sufficient for storing 7 g to 8 kg of the moldable food product.

11. The method according to claim 1, wherein the interior space of each compartment is sufficient for storing 1 teaspoon to 1 gallon of the moldable food product.

12. The method according to claim 1, wherein the plurality of compartments comprises a range from 2 to 72 compartments.

13. The method according to claim 1, wherein the base tray comprises four compartments.

14. The method according to claim 1, wherein the base tray comprises twelve compartments.

15. The method according to claim 1, wherein the compartments further comprise an indicium of a unit of gradation.

16. The method according to claim 15, wherein the indicium is located in the interior space of the compartments so as to imprint the indicium on the moldable food product after increasing the solidity of the moldable food product.

17. The method according to claim 15, wherein the indicium is located on the inter-compartmental walls.

18. The method according to claim 1, wherein the moldable food product is chosen from the group consisting of butter, margarine, shortening, lard, and chocolate.

19. A package of moldable food product comprising:
a base tray having a plurality of compartments arranged in an array, wherein each of the compartments has an interior space defining a volume for storing a moldable food product, an open end, and inter-compartmental walls extending from the open end on at least two sides;
a moldable food product contained in the interior space of each compartment and molded to a shape of the interior space of each compartment; and
a cover which seals the open ends of the compartments.

20. The package of moldable food product according to claim 19, wherein the compartments further comprise an indicium of a unit of gradation.

21. The package of moldable food product according to claim 20, wherein the indicium of a unit of gradation is 1 teaspoon, 1 tablespoon, ¼ cup, ⅓ cup, ½ cup, 1 cup, ¼ lb, ½ lb, 1 lb, 1 g, ¼ kg, ½ kg, 1 kg, 5 mL, 10 mL, 250 mL or 1 ounce.

22. The package of moldable food product according to claim 19, wherein the cover is a removable film.

23. The package of moldable food product according to claim 22, wherein the removable film is perforated so that the compartments can be uncovered individually.

24. The package of moldable food product according to claim 19, wherein the plurality of compartments comprises a range from 2 to 72 compartments and wherein the volume for storing the moldable food product is sufficient for containing the moldable food product in an amount in a range from about 7 g to about 8 kg.

25. The package of moldable food product according to claim 19, wherein the base tray further comprises points of weakness on the inter-compartmental walls so that each compartment may be separated from a remainder of the compartments.

26. The package of moldable food product according to claim 25, wherein the points of weakness are perforations, and wherein the at least two inter-compartmental walls of each compartment can be detached along the points of weakness to remove each compartment from adjacent compartments of the base tray.
